(19) United States
(12) Patent Application Publication
(10) Pub. No.: US 2012/0122619 A1
(43) Pub. Date: May 17, 2012

(54) RATCHET-TYPE TENSIONER

(75) Inventors: Osamu Yoshida, Osaka (JP); Yuji Kurematsu, Osaka (JP); Munehiro Maeda, Osaka (JP)

(73) Assignee: TSUBAKIMOTO CHAIN CO., Osaka (JP)

(21) Appl. No.: 13/277,495

(22) Filed: Oct. 20, 2011

(30) Foreign Application Priority Data
Nov. 11, 2010 (JP) 2010-252844

(51) Int. Cl. F16H 7/08

(52) U.S. Cl. 474/110

(57) ABSTRACT

In a ratchet tensioner, rack teeth on a plunger are engaged by ratchet teeth on one end of a movable plug that slides in a hole in the tensioner housing along a direction orthogonal of the direction of movement of the plunger. The movable plug is prevented from rotating in the hole in which it slides so that the ratchet teeth engage the rack teeth on the plunger smoothly and reliably.

### CROSS REFERENCE TO RELATED APPLICATIONS

This application claims priority on the basis of Japanese patent application filed on Nov. 11, 2010. The disclosure of Japanese application 2010-252844, is hereby incorporated by reference.

### FIELD OF THE INVENTION

The invention relates to a ratchet-type tensioner for applying a tensioning force to a timing chain used for driving one or more camshafts, and sometimes other mechanisms, in an engine.

### BACKGROUND OF THE INVENTION

A typical ratchet-type tensioner includes a plunger slidable in a plunger-accommodating hole in a tensioner housing. An oil chamber is formed by the plunger and the housing. Tensioning force applied to a timing chain, both by a spring in the oil chamber and by oil supplied under pressure to the oil chamber from an external source, urges the plunger in the protruding direction,.

A typical prior art ratchet-type tensioner 500 is disclosed in Japanese Utility Model No. 2559664 and illustrated in FIG. 12. In the tensioner, a piston 526 slides in the tensioner housing 512 in a direction orthogonal to the direction in which a plunger 514 slides. An oil sub-chamber 520 is formed by the piston 526 and the housing 512, and an oil passage 544 supplies oil under pressure to the oil sub-chamber 520 urging the piston away from the plunger 514, a spring 534 biases the piston 526 toward plunger, opposing the force exerted by the oil in sub-chamber 520. Spring 534 is located within an air chamber 528 on the side of piston 526 opposite from the sub-chamber 520. An air hole 532 in communication with the air chamber 528 is closable by a rod 524, to which the piston 526 is attached, when the piston 526 is moved away from the plunger against the biasing force exerted by spring 534.

A rack of teeth 538 is provided on plunger 514, and a plurality of teeth 536 capable of engaging the rack teeth 538is provided at an end of rod 524 opposite form the end that is arranged to close off air hole 532. Surfaces of teeth 536 and 538 for blocking retraction of the plunger are formed at a right angle to a direction in which the plunger 514 moves.

In the prior art tensioner 500, because the plunger 514 and the piston 526 are cylindrical in form, twisting of the piston and rotation of the plunger due to vibration of the engine on which the tensioner is mounted are prevented only by the engagement between the rack teeth 538 of the plunger 514 and the teeth 536 on the piston rod 524. As a result, inconsistent engagement and faulty operation of the ratchet mechanism can occur, and the teeth 536 on the piston rod 524 are liable to be chipped. The ability of the piston and plunger to rotate also opens the possibility of errors in assembly of the tensioner components both in manufacture and in maintenance of the tensioner.

Because the retraction blocking tooth surfaces are formed at a right angle to the direction in which the plunger 514 slides, the plunger cannot move in the retracting direction even if the chain is under excessive tension due to temperature changes and other causes. Thus, excessive tension can cause seizing of the plunger, increased load on the chain, and excessive noise.

The tensioner can be designed to allow a predetermined amount of backlash, corresponding to a presumed maximum retraction of the plunger caused by the excessive tension in the chain during engine operation. However, as the allowed backlash becomes larger, it becomes more difficult to suppress rattling or flapping sounds generated on engine start-up. Countermeasures to reduce these rattling noises, such as adding an orifice mechanism or an oil reserve mechanism, or using a plunger-biasing spring 518 designed to accommodate a higher load either increases the number of parts in the tensioner, increasing its production cost, or results in enlargement of the tensioner.

### SUMMARY OF THE INVENTION

This invention addresses the aforementioned problems by providing a ratchet-type tensioner in which the ratchet mechanism operates with greater reliability and stability, faulty operation is avoided, flapping noises generated when an engine is started are reduced, and seizing of the plunger due to excessive chain tension is avoided.

The ratchet-type tensioner, in accordance with the invention comprises a housing, a plunger, and a movable ratchet plug. The housing has a plunger-accommodating hole having a bottom wall at one end and an opening at an opposite end. The plunger is slidable in a longitudinal direction in the plunger-accommodating hole, and protrudes through the opening of the plunger-accommodating hole in order to apply tension to a traveling transmission chain. The plunger has an exterior wall, and a hollow interior open toward the bottom wall. The plunger and the plunger-accommodating hole cooperatively form an expansible high oil chamber.

A series of rack teeth is formed on the exterior wall of the plunger and extends along the exterior wall along the longitudinal direction of the plunger. An oil supply passage is provided in the housing for flow of oil under pressure from the exterior of the housing to the high oil chamber. A plunger-biasing spring within the high-oil chamber urges the plunger in its protruding direction.

A transverse opening extends through the housing from the exterior of the housing to the plunger-accommodating hole. A movable plug is slidable in this transverse opening in a direction orthogonal to the longitudinal direction of the plunger. The movable plug has teeth formed on an end thereof facing the plunger, and the teeth of the plug are engageable with teeth of the series of rack teeth on the exterior wall of the plunger by sliding movement of the plug toward the plunger.

A plug-biasing spring, having one end engaged with the movable plug, urges the plug toward the plunger, whereby the teeth on the end of the movable plug are urged into engagement with rack teeth on the plunger.

A spring-retainer fits in the transverse opening and is engaged by the opposite end of the plug-biasing spring.

The teeth of the set of rack teeth on the plunger and the teeth on the movable plug have forward faces facing toward the direction of protrusion of the plunger and rearward faces facing toward the direction of retraction of the plunger. The rearward faces of the teeth of the set of rack teeth on the plunger and the forward faces of the teeth on the movable plug have an inclination such that their mutual engagement can block retracting movement of the plunger at least when the net force exerted on the plunger in the retracting direction is less than a predetermined force. The forward faces of the teeth of the set of rack teeth on the plunger and the rearward faces of the teeth on the movable plug having an inclination sufficient to apply a force urging the movable plug in a direction away from the plunger to an extent sufficient to permit protruding movement of the plunger.

The movable plug and the transverse opening have cooperating surfaces preventing rotation of the movable plug in the opening while permitting movement of the movable plug in the transverse opening toward and away from the plunger. The cooperating surfaces ensure that the teeth of the movable plug are maintained in alignment with the rack teeth on the plunger.

The ratchet tensioner having the above-described features can operate reliably and stably. The teeth of the movable plug can accurately engage the rack teeth on the plunger across the full widths of the tooth faces face width, and faulty operation of the ratchet mechanism caused by twisting of the movable plug, or resulting from erroneous installation of the movable plug, can be avoided.

The movable plug, except for the rotation-preventing surface thereof, can be in the form of a circular cylinder having an axis extending in a direction transverse to the direction of movement of the plunger. Preferably, the axial length of the circular cylinder is greater than its diameter. This relationship between the length and diameter of the cylinder contributes to smooth operation of the tensioner by reducing inclination of the movable plug due to excessive loading, and thereby preventing biased wear of the ratchet components.

The cooperating surfaces preferably comprise a protruding spline and a groove. The spline is provided on an outer peripheral surface of the movable plug and extends along the direction orthogonal to the longitudinal direction of the plunger. The groove is formed on an inner peripheral surface of the transverse opening, extends along the orthogonal direction and mates with the spline.

As mentioned above, cooperation of the spline and groove not only prevents the outer peripheral surface of the movable plug from turning with respect to the inner peripheral surface of the transverse opening, promoting smooth operation. In addition, providing the spline on the outer peripheral surface of the movable plug and providing its cooperating groove in the transverse opening of the housing instead of in the outer peripheral surface of the movable plug simplifies manufacture of the ratchet mechanism, as it is more difficult to machine convex spline in the inner peripheral surface of a hole.

The movable plug is preferably formed with a blind, spring-receiving hole having an opening facing toward the spring retainer. The plug-biasing spring, which is preferably a coil spring under compression, extends into the blind, spring-receiving hole and protrudes through the opening thereof facing toward the spring retainer. Because the spring extends into a hole in the movable plug instead of engaging the end or fitting around the outer peripheral surface of the movable plug, the ratchet structure is simplified, and it becomes possible to reduce the size of the tensioner.

In a preferred embodiment of the tensioner, the rearward faces of the rack teeth of the plunger and the forward faces of the teeth of the movable plug have the same first inclination relative to the direction orthogonal to the direction of movement of the plunger. The forward faces of the rack teeth of the plunger and the rearward faces of the teeth of the movable plug can have the same second inclination relative to the orthogonal direction, and the angle of the first inclination is smaller than the angle of the second inclination. The relationship between the angles of the tooth faces allows the plunger of the tensioner to protrude smoothly during operation of an engine while blocking retraction of the plunger. However, the slope of the rearward facing teeth of the plunger and the cooperating forward-facing teeth of the movable plug can allow the plunger to move in the retracting direction when the load on the plunger becomes excessive, while avoiding the wear and chipping of teeth that occur in conventional ratchet tensioners, and while avoiding excessive impact on the plug-biasing spring.

If the angle of the first inclination is greater than zero, the rack teeth of the plunger and the teeth of the movable plug allow the plunger to be moved in the retracting direction when the net force exerted on the plunger in the retracting direction is greater than a predetermined force. Consequently, the tensioner, when used to maintain tension in an engine timing chain, can prevent retraction of the plunger on engine start-up, but can allow retraction of the plunger when the timing chain is under excessive tension during engine operation. With this tooth relationship, it is possible to prevent the rack teeth of the plunger from disengaging from the ratchet teeth as a result of the retracting force exerted on the plunger during engine start-up. Thus, it is possible to avoid backlash on starting the engine.

If the forward faces of the rack teeth of the plunger and the rearward faces of the teeth of the movable plug have the same second inclination relative to the orthogonal direction, and the angle of the first inclination is smaller than the angle of the second inclination, the tensioner, when used to maintain tension in an engine timing chain, can compensate for chain elongation by providing for protruding movement of the plunger, while preventing retraction of the plunger on engine start-up, and can also allow retraction of the plunger when the timing chain is placed under excessive tension during engine operation.

Thus, if an excessive load is applied to the plunger during engine operation, for example, because the plunger has advanced excessively due to temperature changes or other causes, it is possible to prevent seizure of the plunger reliably by selecting a biasing spring that exerts an appropriate force on the movable plug.

By restricting movement of the plunger in the retracting direction, the ratchet mechanism according to the invention can prevent backlash and reduce flapping noises generated by a timing chain. In addition, because forces exerted on the plunger both in the protruding direction and in the retracting direction, can be balanced by the forces exerted by the plug-biasing spring, no special high load-accommodating plunger biasing spring, orifice mechanism or oil reserve mechanism are required. Accordingly, it is possible to reduce the number of parts and the manufacturing cost of the tensioner and to downsize the tensioner.

### BRIEF DESCRIPTION OF DRAWINGS

FIG. 1 is a schematic front elevational view of an engine timing drive incorporating a ratchet-type tensioner in accordance with the invention;

FIG. 2 is a cross-sectional view of the ratchet-type tensioner shown in FIG. 1, and includes an enlarged sectional view the ratchet mechanism;

FIG. 3 is an enlarged sectional view showing rack teeth on the plunger cooperating with ratchet teeth on a movable plug;

FIG. 4 is a sectional view taken on section plane 4-4 in FIG. 2;

FIG. 5 is an exploded view of movable plug, a plug-biasing spring, and a spring retainer;

FIG. 6 is a diagram showing the engagement of the rack teeth on a plunger with the ratchet teeth on a movable plug as the plunger moves in the protruding direction on engine start-up;

FIG. 7 is a diagram showing the engagement of the rack teeth on a plunger with the ratchet teeth on a movable plug as the plunger moves in the retracting direction on engine start-up;

FIG. 8 is a diagram showing the engagement of the rack teeth on a plunger with the ratchet teeth on a movable plug as the plunger starts move in the retracting direction as a result of an excessive tension in the engine timing chain;

FIG. 9 is a diagram showing the engagement of the rack teeth on a plunger with the ratchet teeth on a movable plug as the plunger continues to move in the retracting direction as a result of an excessive tension in the engine timing chain;

FIG. 10 is a diagram showing the engagement of the rack teeth on a plunger with the ratchet teeth on a movable plug as the plunger stops moving in the retracting direction;

FIG. 11 is an exploded view of movable plug, a plug-biasing spring, and a spring retainer in a second embodiment of the invention; and

FIG. 12 is a cross-sectional view of a prior art ratchet-type tensioner.

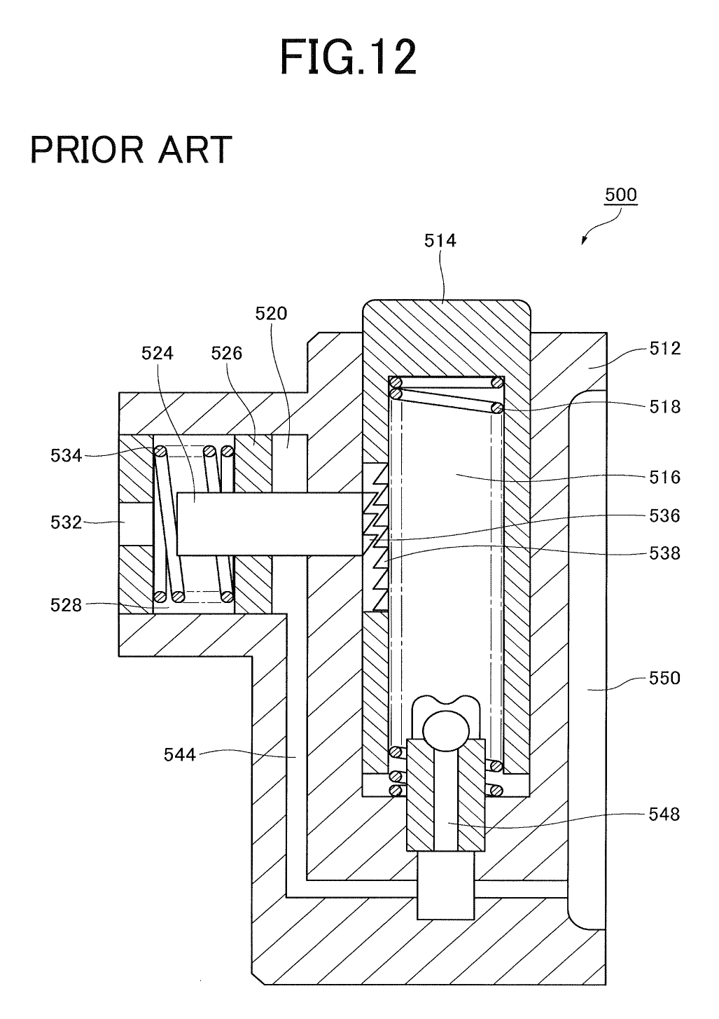

### DETAILED DESCRIPTION OF THE PREFERRED EMBODIMENTS

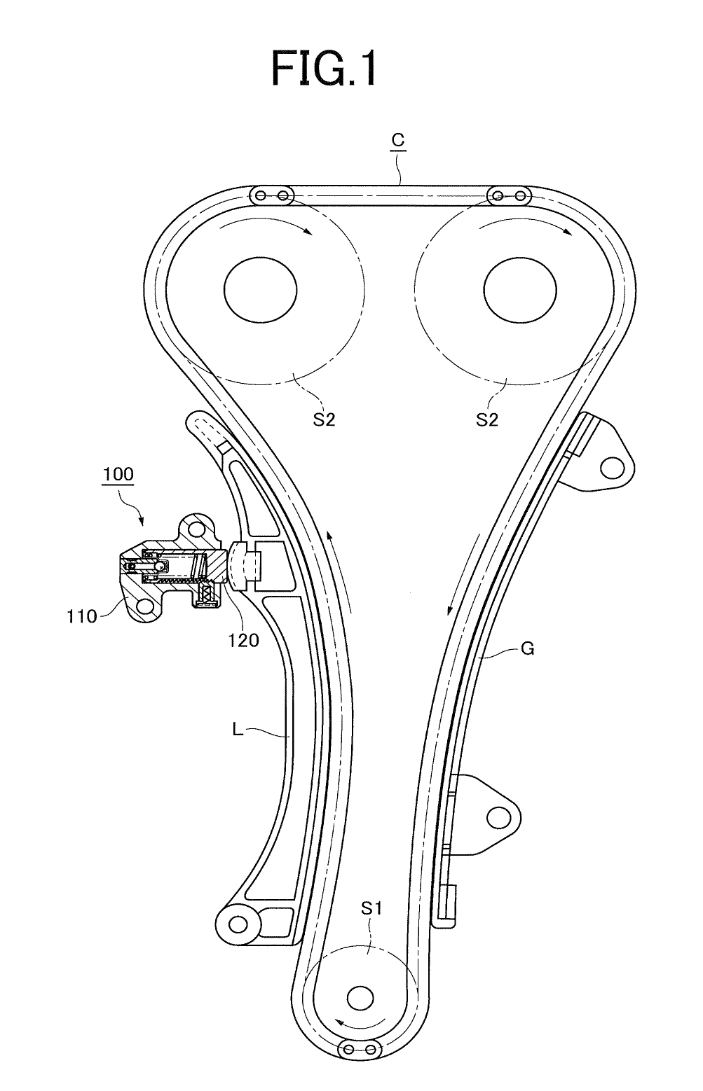

In the timing transmission shown in FIG. 1, a timing chain C is driven by a crankshaft sprocket Si and drives a pair of camshaft sprockets S2. Arrows show the direction of rotation of the sprocket and the direction of travel of the chain. A ratchet-type tensioner 100, is attached to an engine block (not shown) adjacent the slack side of a timing chain C, i.e., the part of the chain that travels from the crankshaft sprocket Si toward a first one of the two camshaft sprockets S2. A plunger 120 protrudes from a tensioner housing 110 and applies tension to the slack side of the timing chain C through a pivoted lever L on which the chain slides, by pressing the lever at a location remote from the lever's pivot axis. A stationary guide G, which is also attached to the engine block, guides the tension side of the timing chain C, i.e., the part of the chain that travels from the second camshaft sprocket S2 toward the crankshaft sprocket S1.

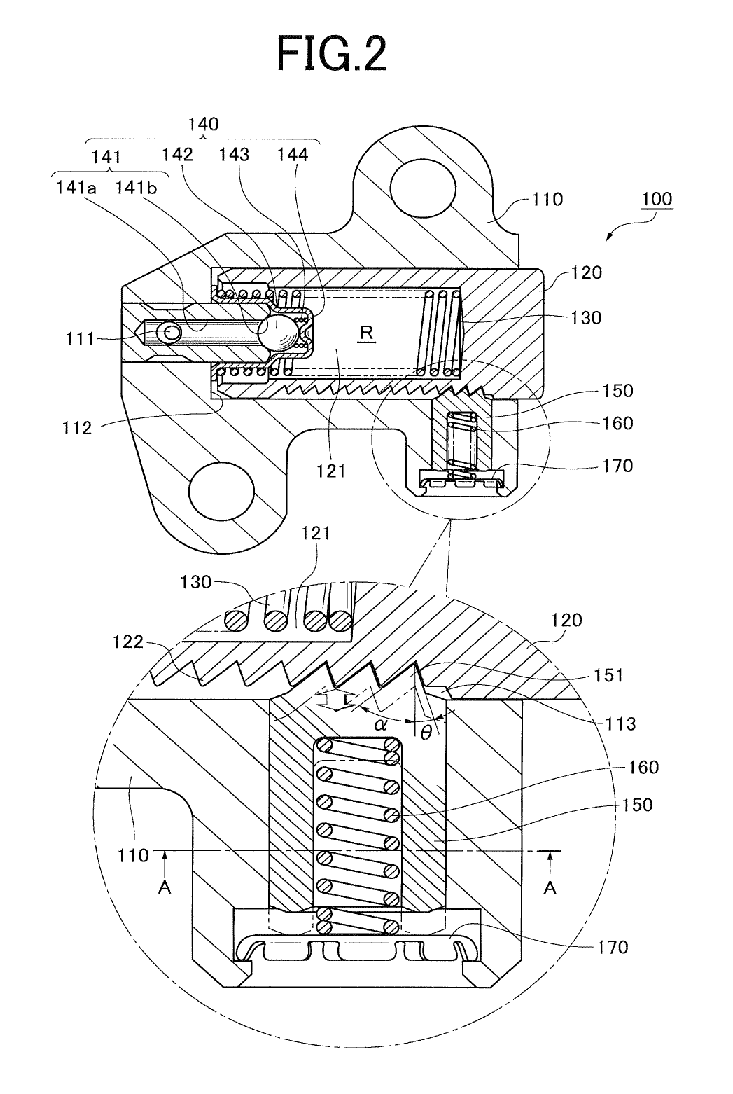

As shown in FIG. 2, the tensioner 100 comprises a housing 110, a plunger 120 slidable in a plunger-accommodating hole 112 in the housing and protruding from the plunger-accommodating hole, an oil supply passage 111 for introducing oil supplied under pressure from an engine block to a high pressure oil chamber R formed by the plunger and the housing. A plunger biasing spring 130 within the high-oil chamber extends into a hollow interior space 121 within the plunger 120, and urges the plunger in the protruding direction. A check valve assembly 140 in the bottom of the plunger-accommodating hole 112 blocks reverse flow of oil from the high-oil chamber R to the oil supply passage 111.

The tensioner 100 also includes a movable plug 150 that fits slidably in a cylindrical hole 113 which is transverse to the plunger-accommodating hole 112. The movable plug 150 slides in a direction orthogonal to the direction in which the plunger 120 moves. A plug-biasing coil spring 160 urges the plug 150 so that ratchet teeth 151 formed on the end of the plug facing the plunger engage teeth of a longitudinally extending rack of teeth 122 formed on the outer surface of the plunger. Spring 160 is seated on a spring-retainer 170 which fits into a recess at an end of hole 113 remote from the plunger 120.

The check valve unit 140 comprises a ball seat 141 having an oil passage 141a communicating with the oil supply passage 111 of the housing 110, a check ball 142 that seats on a an end 141b of the ball seat 141, a ball-biasing spring 143 that presses against the ball 142 and urges the ball against the ball seat 141, and a bell-shaped retainer 144 that supports the ball-biasing spring 143 and restricts movement of the check ball 142. Although the above-described structure is a preferred structure for the check valve unit, various alternative structures can be utilized to block reverse flow of oil, and can be adopted for the check valve unit.

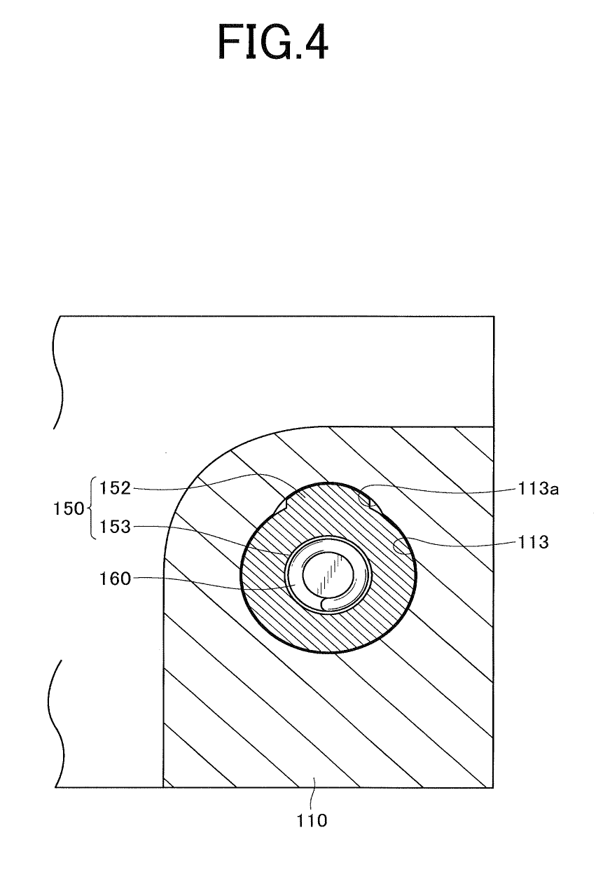

As shown in FIGS. 2 and 4, the movable plug 150 is allowed to slide in its hole 113 in a direction orthogonal to the direction of movement of the plunger, but is prevented from rotating in hole 113, regardless of whether or not the ratchet teeth 151 on the end of the plug are engaged with the rack teeth 122 on the plunger. Thus, even if the plunger 120 vibrates as the engine operates, the ratchet teeth 151 of the movable plug can engage the rack teeth 122 on the plunger accurately across the entire widths of the tooth faces. As shown in FIG. 4, rotation of the plug 150 is prevented by a convex spline 152 that extends linearly along the outer peripheral surface of the plug in the direction of movement of the plug, and a mating concave groove 113a that extends longitudinally along the inner peripheral surface of hole 113 along the direction of sliding of the movable plug. The mating slide and groove maintain the ratchet teeth on the movable plug in alignment with the rack teeth on the plunger without the need for complex manufacturing steps.

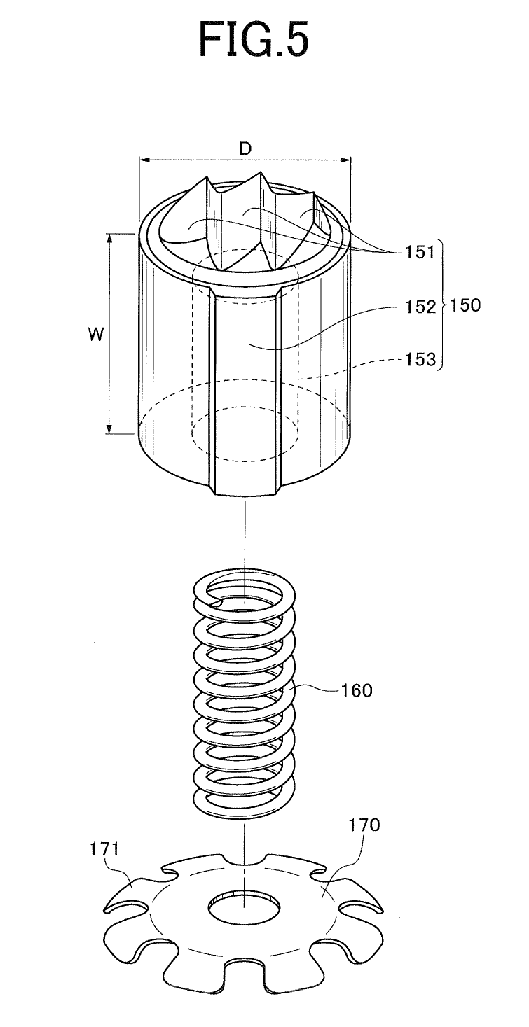

As shown in FIG. 5, the length W of the movable plug 150 is greater than its diameter D. Because the length of the plug is greater than the diameter, inclination of the plug relative to its direction of sliding in hole 113, which is otherwise likely to occur, is prevented, reducing biased wear of the plug even if excessive loads are applied to the plug.

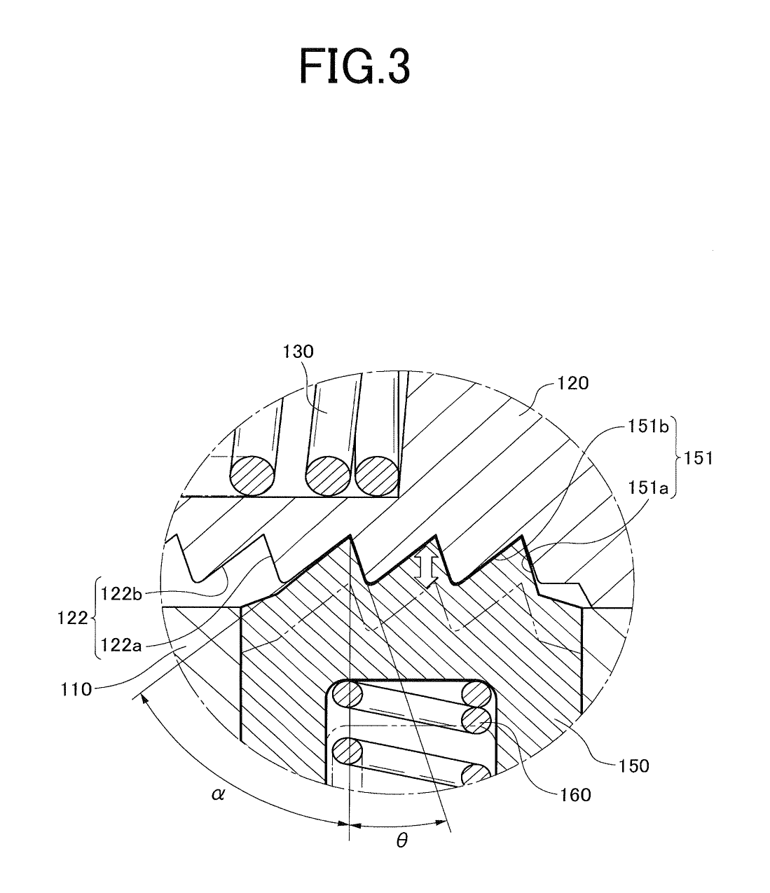

The three ratchet teeth 151 having teeth intervals of equal pitch and the same tooth height are provided at the plunger-side edge portion of the movable plug of the present embodiment as shown in FIGS. 3 and 5 so that they engage with the rack teeth 122 engraved on the plunger side surface while homogeneously dispersing an engagement load.

The plug-biasing coil spring 160 is concentric with the movable plug, and extends into a spring-receiving hole 153 formed in the plug. The plug-biasing spring 160 can be selected set so that the biasing force which it exerts on the plug 150 is greater than the opposing component of force along the direction in which the plug slides, generated in reaction to the force exerted on the plunger in the retracting direction on engine start-up, but less than the component of force exerted on the plug in reaction to the force exerted on the plunger when tension in the transmission chain becomes excessive after engine start-up when the engine is in operation.

The spring retainer 170 is in the form of a stopping washer having a plurality of uniformly spaced ligulas 171 projecting from its perimeter. As shown in FIG. 2, the spring retainer is fitted into an annular groove adjacent the end of hole 113 remote from the plunger. The spring retainer 170 is resilient, and the plug-biasing spring 160 is in compression between the spring retainer 170 and the closed end of the spring-receiving hole 153 formed in the plug.

The relationship between the rack teeth 122 of the plunger 120, the ratchet teeth 151 on the movable plug 150, and the plug-biasing spring 160, will be explained below in detail with reference to FIGS. 3 and 6 through 8.

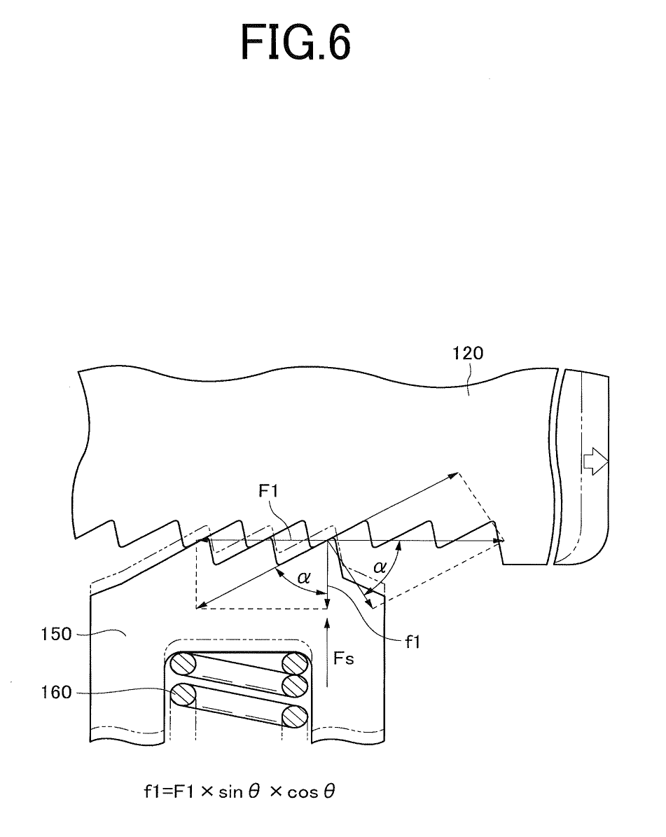

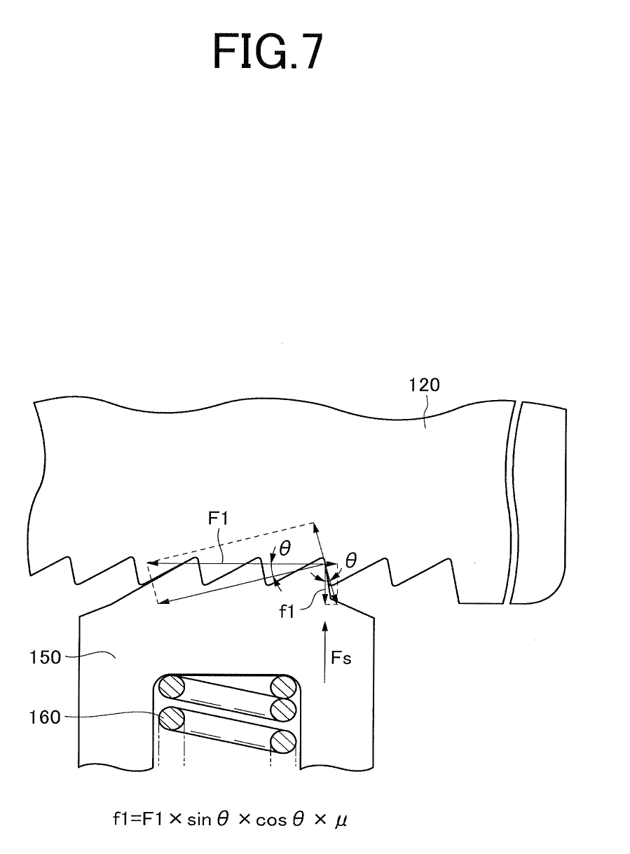

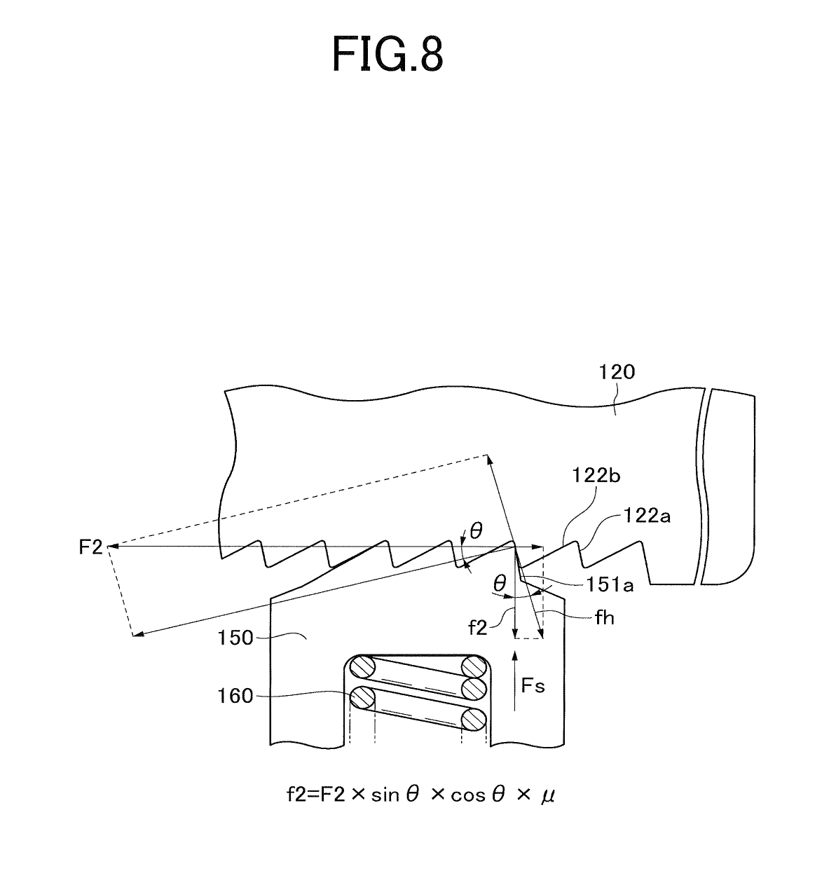

As shown in FIG. 6, when the plunger 120 moves in the protruding direction on starting the engine and during normal driving after starting an engine, the relationship between the force component F1, in the direction in which the movable plug slides, and the biasing force FS exerted by the plug-biasing spring 160 is always F1>FS. Accordingly, the plunger 120 can advance by pushing back the movable plug. As shown in FIG. 7, the biasing force FS of the plug-biasing spring 160 is greater than the magnitude of the force component F1 generated in reaction to a force F1 applied to the plunger 120 in the retracting direction by the traveling chain on engine start-up. On the other hand, as shown in FIG. 8, the biasing force FS is smaller than the magnitude of the force component F2 generated in reaction to the force F2 applied to the plunger 120 in the retracting direction when the tension in the traveling transmission chain becomes excessive after starting the engine.

Thus, the relationship between forces F1 and FS is always f1>FS as the plunger protrudes on engine start-up, and the plunger can advance, pushing the lever L (FIG. 1) against the slack side of the transmission chain. However, as the plunger is pushed back, the force FS exerted by the plug-biasing spring 160 is larger than the magnitude of force component F1, and engagement of the teeth on the movable plug with the rack teeth on the plunger restricts displacement of the plunger in the retracting direction.

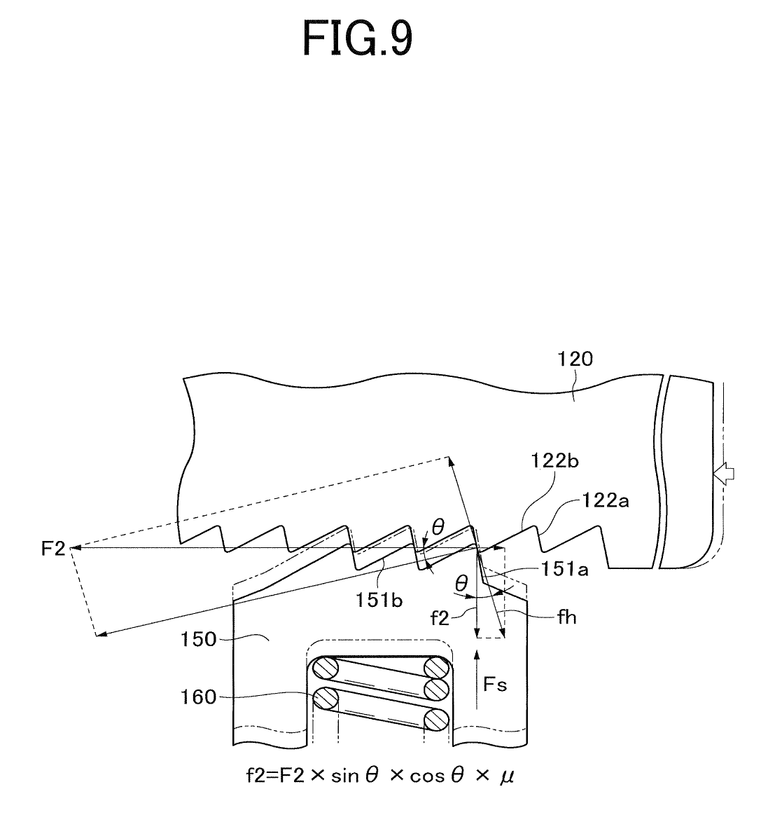

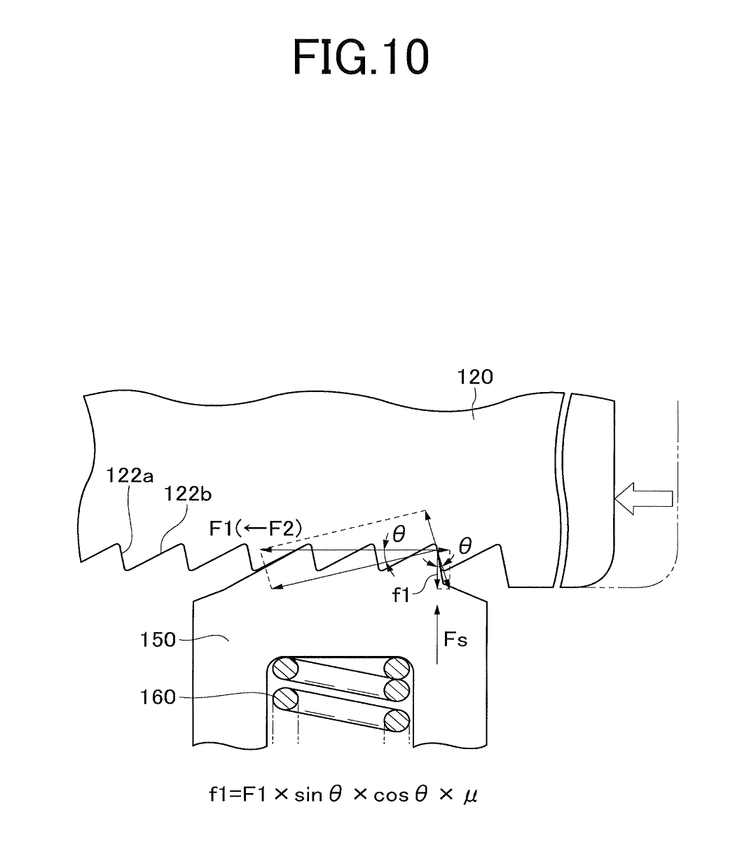

On the other hand, a larger force F2 is exerted in the retracting direction on the plunger 120 by the transmission chain when the tension in the chain becomes excessive after starting the engine. The force component F2 then becomes larger than the biasing force FS exerted by the plug-biasing spring 160. Then, the ratchet teeth 151 of the movable plug can disengage from the rack teeth 122 of the plunger 120 as shown in FIG. 9, and the plunger 120 can move in the retracting direction by a distance corresponding to the pitch of one tooth, or by a distance corresponding to the pitches of several teeth until the magnitude of force component F2 becomes smaller than the biasing force FS exerted by the plug-biasing spring 160. Accordingly, the ratchet mechanism allows setback of the plunger, as shown in FIG. 10, when tension in the chain becomes excessive after engine start-up.

It is possible to predetermine the conditions under which the ratchet teeth on the movable plug disengage the rack teeth on the plunger and allow the plunger to retract, by selecting a biasing spring 160 that is capable of exerting an appropriate biasing force FS.

As shown in FIG. 3, the rack teeth 122 of the plunger 120 have rearward-facing surfaces 122a that are inclined at an angle θ relative to the direction of plunger movement. The ratchet teeth 151 on the movable plug have forward facing surfaces, i.e., counterfaces, 151a, which are also inclined at an angle θ relative to the direction of plunger movement. Consequently, as shown in FIG. 8, when a force F2 is exerted on the plunger due to excessive chain tension after the engine is started, a component fh of the force F2 acts on the faces 151a of the movable plug through faces 122a on the plunger rack teeth. In turn, a component F2 of force fh acts in the direction of movement of the movable plug 150, and if the magnitude of force F2 exceeds the biasing force FS exerted by spring 160 on the movable plug, the movable plug is moved back. Rack teeth 122 of the plunger slide on tooth faces 151a and the ratchet teeth 151 disengage the rack teeth 122, allowing the plunger to move in the retracting direction by one or several teeth as shown in FIGS. 9 and 10.

The angle θ of inclination of the rearward-facing plunger rack tooth surfaces 122a is smaller than the angle a of inclination of the forward facing rack tooth surfaces 122b. This relationship between angles θ and a prevents the ratchet teeth 151 of the movable plug from disengaging from the rack teeth 122 of the plunger when a force F1 is exerted on the plunger 120 by the traveling chain on starting the engine.

Referring to FIG. 9, when the plunger 120 advances excessively due to temperature changes in the engine or other causes, and an excessive force F2 is exerted on the plunger in the retracting direction, the relationship between the plug biasing force FS and the magnitude of force component F2 due to force F2 is:

F2=F2×cos θ×sin θ×μ

F2>FS

where μ here is a coefficient of friction between the rack teeth 122 of the plunger 120 and the ratchet teeth 151 of the movable plug.

However, on engine start-up, when a force F1 is exerted on the plunger in the retracting direction and the ratchet teeth restrict retracting movement of the plunger 120, the relationship between the plug biasing force FS and the magnitude of force component F1 due to force F1 is:

F1=F1×cos θ×sin θ×μ

F1<FS

Broken lines in FIGS. 9 and 10, indicate the position of the protruding end of the plunger when excessive tension is generated in the chain after starting the engine, i.e., the position of the plunger 120 in FIG. 8.

When the tension of the chain becomes excessive after starting the engine, a component fh of force F2 acts on the forward-facing tooth surfaces 151a of the movable plug through rearward-facing rack tooth surfaces 122a on the plunger. A smaller component f of force F2 acts in the direction of sliding movement of the movable plug 150. Since the magnitude of force F2 exceeds the biasing force FS exerted on the movable plug, the movable plug slides away from the plunger, and the plunger 120 begins to retract. As long as the magnitude of force F2 exceeds the biasing force FS, the plunger can continue to retract as depicted in FIG. 9, and the teeth 151 of the movable plug can disengage the rack teeth 122 of the plunger 120.

When the ratchet teeth 151 disengage from rack teeth 122 the plunger 120 continues to retract, and as the plunger continues to retract, the forward facing surfaces 122b of its rack teeth begin to slide against the rearward facing surfaces 151b of teeth 151 on the movable plug. After the rack teeth move over the ratchet teeth 151, succeeding new rearward tooth faces 122a on the plunger abut forward faces 151a of the ratchet teeth 151 as shown in FIG. 10. The disengagement of the ratchet teeth from the rack teeth and allows the rearward displacement of the plunger, and the plunger can retract through a distance corresponding to one or several rack teeth until the overload is relieved.

The engagement of the ratchet teeth 151 of the movable plug with the rack teeth on the side of the plunger occurs without twisting so that contact between the ratchet teeth and the rack teeth occurs across the full face widths of the teeth. Twisting of the movable plug is prevented by the cooperation of the convex spline 152 (FIGS. 4 and 5) that extends along the direction of sliding movement of the plug 150 on the outer peripheral surface of the plug and the concave groove 113a (FIG. 4), formed provided on the inner peripheral surface of hole 113 and also extending along the direction of movement of plug 150. The mating relationship between the spline and the concave groove make it possible to achieve reliable and stable operation of the ratchet mechanism of the tensioner, to eliminate erroneous operation of the ratchet mechanism by avoiding the twisting, and to avoid assembly errors. In addition, it is easier to manufacture a protruding spline on the exterior of a movable plug and a mating groove on the interior surface of the plug-receiving hole, than it is to form a protruding spline on the inner surface of the plug-receiving hole.

Because the length of the movable plug is greater than its diameter, it is possible to reduce inclination of the plug and thereby eliminate biased wear of the plug, and to operate the ratchet mechanism more smoothly even if an excessive load is applied to the movable plug.

Because the plug-biasing spring 160 is inserted into the movable plug along the direction of movement of the plug, the configuration and mounting of the movable plug is be simplified, and the overall size of the ratchet tensioner can be smaller than that of a ratchet tensioner in which the plug-biasing spring surrounds the outer peripheral surface of the movable plug.

Because the biasing force FS exerted by the plug-biasing spring 160 is can be greater than the magnitude of force component F1 generated on starting the engine but smaller than the magnitude of the force component f2 generated when the tension of the chain becomes excessive after starting the engine, it becomes possible to reduce the retracting displacement of the plunger 120 on starting the engine, and to reduce the flapping noise of the timing chain. However, it is also possible to prevent seizing of the plunger 120 by allowing retracting displacement of the plunger 120 to take place when excessive tension occurs in the transmission chain after starting the engine. It is also possible to reduce a number of parts and production cost and to downsize the tensioner without requiring any special high load-accommodating plunger biasing spring, orifice mechanism, or oil reserve mechanism.

Because the rearward- and forward-facing surfaces 122a and 122b of the rack teeth on the plunger and the forward- and rearward-facing surfaces 151a and 151b of the ratchet teeth on the movable plug are inclined respectively at angles θ and α, and angle α is greater than angle θ, it becomes possible to allow retracting displacement and to prevent wear of the tips of the teeth 151 and 122 when the tension of the chain becomes excessive after starting the engine. It is also possible to avoid excessive impact on the plug-biasing spring 160 and to improve its durability.

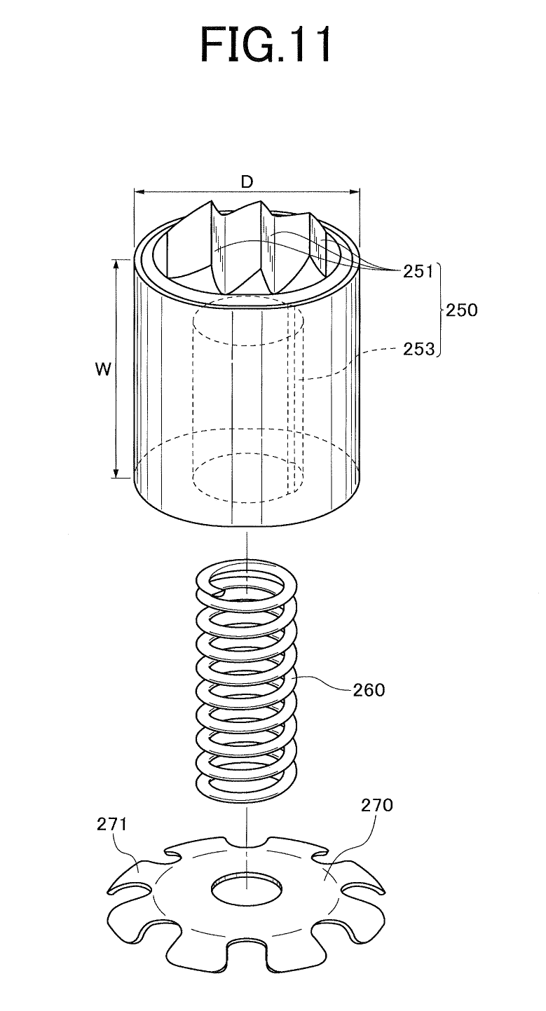

In a second embodiment illustrated in FIG. 11, parts corresponding to those in the above-described embodiment are designated by reference numbers that exceed the numbers of the parts in the above-described embodiment by 100.

In this second embodiment, the movable plug 250 has an elliptical cross-section, and the hole (not shown) in which the plug slides in a direction orthogonal to the direction of movement of the plunger has a similar elliptical cross-section conforming to that of the movable plug. Consequently, the plug can slide in the hole, but cannot rotate. Thus the teeth 251 are maintained in alignment with the rack teeth on the plunger even if the tensioner is subject to vibration. The alignment of the teeth of the movable plug with the rack teeth on the plunger is maintained by the elliptical shapes of the movable plug and the hole in which it slides, and is independent of the engagement of the teeth. Moreover the teeth engage one another accurately over the full widths of their faces.

Here, as in the first embodiment, the length W of the movable plug is greater than its maximum lateral dimension as shown in FIG. 11. Consequently, inclination of the movable plug due to excessive load is reduced.

Three ratchet teeth 251, having a uniform pitch and having the same tooth height, are provided on the plunger-facing end of the movable plug 250 in order to engage with rack teeth on the side of the plunger while dispersing the load applied to the ratchet teeth by the plunger.

The ratchet-type tensioner of the second embodiment exhibits the same reliable and stable operation as exhibited by the tensioner of the first embodiment. With the second embodiment, it is possible to eliminate faulty operation of the ratchet mechanism by avoiding twisting of the movable plug. Manufacture of the tensioner in accordance with the second embodiment is simplified because the precision machining required to produce a spline on the movable plug and a mating groove in the housing is unnecessary.

The configuration of the tensioner according to the invention can be modified in many respects. For example, instead of supplying oil directly from the engine block through an oil passage in the tensioner housing, the housing can be provided with a recess that serves as an oil reservoir. The check valve can be located at a position other than at the bottom of the plunger-accommodating hole and can have any of various configurations.

The biasing force exerted by the plug-biasing can have any value provided that it is greater than the magnitude of the force component exerted on the movable plug by the plunger on engine start-up but less than the magnitude of the force component exerted on the movable plug by the plunger when the tension in the chain becomes excessive after starting the engine. It is preferable take into account the coefficient of friction between the teeth of the plunger and the teeth of the movable plug when selecting the plug-biasing spring.

The mechanism for preventing rotation of the movable plug in order to ensure proper engagement of the ratchet teeth on the plug with the rack teeth on the plunger can be composed of a spline on the movable plug and a groove in the hole in which the plug slides, or alternatively, a spline formed on the wall of the hole and a longitudinal groove formed on the outer surface of the movable plug. Other configurations can be adopted for preventing rotation of the movable plug, for example, shaping the movable plug and the hole in which it slides so that both have an elliptical cross-section.

The specific configuration of the ratchet teeth can also be varied but is preferably such that the teeth on the movable plug engage the rack teeth on the plunger across the full widths of the rack teeth. For example, the plug preferably has three ratchet teeth with a uniform pitch and height so that they engage the rack teeth in such a way as to disperse the load evenly.

What is claimed is:

1. A ratchet-type tensioner, comprising:
a housing having a plunger-accommodating hole having a bottom wall at one end and an opening at an opposite end;
a plunger slidable in a longitudinal direction in the plunger-accommodating hole, and protruding through said opening, for applying tension to a traveling transmission chain, the plunger having an exterior wall and a hollow interior open toward said one end of the plunger-accommodating hole, and the plunger and the plunger-accommodating hole cooperatively forming an expansible high oil chamber;
a series of rack teeth formed on the exterior wall of the plunger and extending along said exterior wall along said longitudinal direction;
an oil supply passage in the housing for flow of oil under pressure from the exterior of the housing to the high oil chamber;
a plunger-biasing spring within the high-oil chamber, urging the plunger in a protruding direction;
a transverse opening extending through the housing from the exterior thereof to the plunger-accommodating hole;
a movable plug slidable in said transverse opening in a direction orthogonal to said longitudinal direction, said movable plug having teeth formed on an end thereof facing said plunger, said teeth formed on an end of the movable plug being engageable with teeth of said series of rack teeth by sliding movement of the plug toward said plunger;
a plug-biasing spring having one end engaged with said movable plug and urging said movable plug toward said plunger whereby the teeth on said end of the movable plug are urged into engagement with rack teeth on the plunger; and
a spring-retaining plug fitting in said transverse opening and engaged by and opposite end of the plug-biasing spring; and
wherein said teeth of the set of rack teeth on the plunger and the teeth on said movable plug have forward faces facing toward the direction of protrusion of the plunger and rearward faces facing toward the direction of retraction of the plunger, the rearward faces of the teeth of the set of rack teeth on the plunger and the forward faces of the teeth on said one end of the movable plug having an inclination such that their mutual engagement can block retracting movement of the plunger at least when the net force exerted on the plunger in the retracting direction is less than a predetermined force, and the forward faces of the teeth of the set of rack teeth on the plunger and the rearward faces of the teeth on said movable plug having an inclination sufficient to apply a force urging the movable plug in a direction away from the plunger to an extent sufficient to permit protruding movement of the plunger; and
wherein said movable plug and said transverse opening have cooperating surfaces preventing rotation of the movable plug in said opening while permitting movement of said movable plug in said transverse opening toward and away from the plunger, whereby the teeth of the movable plug are maintained in alignment with the rack teeth on the plunger.

2. The ratchet-type tensioner according to claim 1, wherein the movable plug, except for the rotation-preventing surface thereof, is in the form of a circular cylinder having an axis extending in said transverse direction and wherein the axial length of said circular cylinder is greater than its diameter.

3. The ratchet-type tensioner according to claim 1, wherein said cooperating surfaces comprise a protruding spline on an outer peripheral surface of the movable plug, said spline extending along said orthogonal direction, and a groove formed on an inner peripheral surface of the transverse opening, said groove also extending along said orthogonal direction and mating with said spline.

4. The ratchet-type tensioner according to claim 3, wherein the movable plug, except for said protruding spline, is in the form of a circular cylinder having an axis extending in said transverse direction and wherein the axial length of said circular cylinder is greater than its diameter.

5. The ratchet-type tensioner according to claim 1, wherein the movable plug is formed with blind, spring-receiving hole having an opening facing toward the spring-retaining plug, and wherein the plug-biasing spring is a coil spring under compression and said plug-biasing spring extends into said blind, spring-receiving hole and protrudes through said opening thereof facing toward the spring-retaining plug.

6. The ratchet-type tensioner according to claim 1, wherein said rearward faces of the rack teeth of the plunger and the forward faces of the teeth of the movable plug have the same first inclination relative to said orthogonal direction and the forward faces of the rack teeth of the plunger and the rearward faces of the teeth of the movable plug have the same second inclination relative to said orthogonal direction, and wherein the angle of said first inclination is smaller than the angle of said second inclination.

7. The ratchet-type tensioner according to claim 1, wherein said rearward faces of the rack teeth of the plunger and the forward faces of the teeth of the movable plug have the same first inclination relative to said orthogonal direction, the angle of said first inclination being greater than zero, whereby the rack teeth of the plunger and the teeth of the movable plug allow the plunger to be moved in the retracting direction when the net force exerted on the plunger in the retracting direction is greater than a predetermined force, whereby the tensioner, when used to maintain tension in an engine timing chain, can prevent retraction of the plunger on engine start-up, but can allow retraction of the plunger when the timing chain is under excessive tension during engine operation.

8. The ratchet-type tensioner according to claim 1, wherein said rearward faces of the rack teeth of the plunger and the forward faces of the teeth of the movable plug have the same first inclination relative to said orthogonal direction, the angle of said first inclination being greater than zero, whereby the rack teeth of the plunger and the teeth of the movable plug allow the plunger to be moved in the retracting direction when the net force exerted on the plunger in the retracting direction is greater than a predetermined force, and wherein the forward faces of the rack teeth of the plunger and the rearward faces of the teeth of the movable plug have the same second inclination relative to said orthogonal direction, and wherein the angle of said first inclination is smaller than the angle of said second inclination, whereby the tensioner, when used to maintain tension in an engine timing chain, can compensate for chain elongation by protruding movement of the plunger, and can prevent retraction of the plunger on engine start-up, but can allow retraction of the plunger when the timing chain is under excessive tension during engine operation.

9. A ratchet-type tensioner, comprising:
a housing body provided with an oil supplying passage formed for external oil;
a plunger slidably projecting from a plunger storing hole of the housing body toward a traveling chain;
a plunger biasing spring that is stored in a high-pressure oil chamber formed between a plunger storing hole of the housing body and a hollow portion of the plunger and is biased in a direction in which the plunger projects;
a columnar ratchet that is fittingly inserted into a ratchet storing hole of said housing body and slides in a direction orthogonal to the direction in which the plunger advances/sets back;
a ratchet biasing spring that biases the ratchet so that ratchet teeth provided at a plunger-side edge portion of the ratchet engage with rack teeth engraved on a plunger side surface; and
a spring anchoring plug fitted in a vicinity of a rear end of said ratchet storing hole to seat the ratchet biasing spring;
an engagement matching mechanism for engaging the ratchet teeth of said ratchet with the rack teeth on the side surface of said plunger without twisting across the whole range of face width being configured in a condition of stopping an outer peripheral surface of the ratchet from turning with respect to an inner peripheral surface of said ratchet storing hole.

10. The ratchet-type tensioner according to claim 9, wherein a biasing force of said ratchet biasing spring is set to be greater than a component of force in the slide direction of the ratchet generated in a reactive force that sets back the plunger from the traveling chain side in starting the engine and to be smaller than a component of force in the slide direction of the ratchet generated in a reactive force that sets back the plunger from the traveling chain side when a tension of the chain is excessive after starting the engine.

11. The ratchet-type tensioner according to claim 9, wherein the rack teeth of said plunger are concavo-convexly formed of stop surfaces inclining toward a plunger advancing side with respect to the slide direction of said ratchet and slide surfaces inclining toward a plunger setback side with respect to the slide direction of said ratchet; and the ratchet teeth of said ratchet are concavo-convexly formed of stop counterfaces inclining toward the plunger advancing side with respect to the slide direction of said ratchet and slide counterfaces inclining toward the plunger setback side with respect to the slide direction of said ratchet.
